(19) United States
(12) Patent Application Publication
(10) Pub. No.: US 2020/0326956 A1
(43) Pub. Date: Oct. 15, 2020

(54) COMPUTING NODES PERFORMING AUTOMATIC REMOTE BOOT OPERATIONS

(71) Applicant: Nutanix, Inc., San Jose, CA (US)

(72) Inventor: Sebastiaan Gerhardus Johannes Raayman, Sinsheim (DE)

(73) Assignee: Nutanix, Inc., San Jose, CA (US)

(21) Appl. No.: 16/380,240

(22) Filed: Apr. 10, 2019

(51) Int. Cl. G06F 9/4401; G06F 9/455

(52) U.S. Cl. CPC G06F 9/4416; G06F 2009/45575; G06F 9/45558

(57) ABSTRACT

Examples described herein may include remote boot operations based on failed cluster checks. An example method includes retrieving a boot image and configuration parameters from local storage of a computing node of a computing node cluster, and performing a cluster check at the computing node based on the boot image and the configuration parameters. The method further includes, in response to failing the cluster check, retrieving a remote boot image and remote configuration parameters from a remote computing node via a network and performing boot operations at the computing node using the remote boot image and the remote configuration parameters.

### TECHNICAL FIELD

Examples described herein relate generally to distributed computing systems. Examples of virtualized systems are described. Examples of distributed computing systems described herein may facilitate transition to use of remote boot operations.

### BACKGROUND

A virtual machine (VM) generally refers to a software-based implementation of a machine in a virtualization environment, in which the hardware resources of a physical computer (e.g., CPU, memory, etc.) are virtualized or transformed into the underlying support for the fully functional virtual machine that can run its own operating system and applications on the underlying physical resources just like a real computer.

Virtualization generally works by inserting a thin layer of software directly on the computer hardware or on a host operating system. This layer of software contains a virtual machine monitor or “hypervisor” that allocates hardware resources dynamically and transparently. Multiple operating systems may run concurrently on a single physical computer and share hardware resources with each other. By encapsulating an entire machine, including CPU, memory, operating system, and network devices, a virtual machine may be completely compatible with most standard operating systems, applications, and device drivers. Most modern implementations allow several operating systems and applications to safely run at the same time on a single computer, with each having access to the resources it needs when it needs them.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine may not be utilized to perform useful work. This may be wasteful and inefficient if there are users on other physical machines which are currently waiting for computing resources. Virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

As virtualized systems grow in prevalence and complexity, computing node failures have significant impact on productivity. Solutions to improve reliability and robustness of computing nodes is desired to reduce the impacts of failures.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a distributed computing system in accordance with an embodiment of the present disclosure.

FIG. 2 is a block diagram of a distributed computing system in accordance with an embodiment of the present disclosure.

FIG. 3 is a flowchart of a method for remote boot support in a distributed computing system in accordance with some embodiments of the disclosure.

FIG. 4 depicts a block diagram of components of a computing node in accordance with an embodiment of the present disclosure.

### DETAILED DESCRIPTION

This disclosure describes embodiments to support booting a computing node based on remotely stored data in a distributed computing system. Typically, when a computing node encounters a failure, such as a hardware or software failure, the computing node will go offline until a repair is made. This can be costly in terms of lost productivity due to operation of the distributed system being slowed or completely disrupted when a computing node fails. This disclosure describes embodiments for booting a computing node using boot images stored remotely from the computing node in response to a failure. That is, the computing node may automatically switch over to booting from the remote software boot images when a failure is detected. The remote software boot images may be stored and updated periodically and/or before a software or hardware upgrade. The remote software boot images are stored in response to a determination that the computing node is operating normally (e.g., as expected) using the software boot images. In some examples, a single set of common software boot images may be stored for the computing nodes of the distributed computing system, and each computing node may use the common set of software boot images for a remote boot operation. In this example, individual configuration files for each computing node may also be stored to supplement the common set of software boot images, which may be used to provide node-specific configuration information, such as an internet protocol (IP) address, while performing a remote boot operation. Having an automatic fail-over to remote software boot images when a computing node detects a failure may reduce an impact of a failed computing node as compared with the computing node going completely offline and impacting the distributed computing system

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

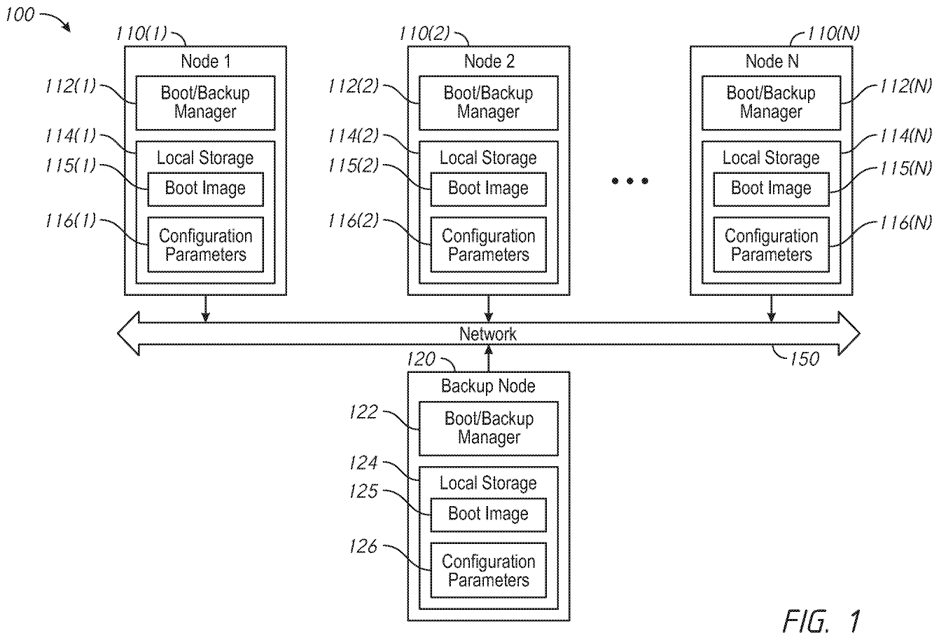

FIG. 1 is a block diagram of a distributed computing system (system) 100 arranged in accordance with examples described herein. The system 100 may include computing nodes 110(1)-(N) and a backup node 120. The computing nodes 110(1)-(N) may be coupled to each other and to the backup node 120 via a network 150, such as a wired network, a wireless network, or combinations thereof. The computing nodes 110(1)-(N) and the backup node 120 may each include a server computer, a laptop computer, a desktop computer, a tablet computer, a smart phone, or any other type of computing device capable of being installed in a server rack. While the system 100 is depicted with at least three computing nodes, more or fewer of the computing nodes 110(1)-(N) may be included in the system 100 without departing from the scope of the disclosure. In addition, the system 100 may include additional backup nodes without departing from the scope of the disclosure.

Each of the computing nodes 110(1)-(N) may include a respective boot/backup manager 112(1)-(N) and respective local storage 114(1)-(N). The local storage 114(1)-(N) of each of the computing nodes 110(1)-(N) may be configured to store a respective boot image 115(1)-(N) and respective configuration parameters 116(1)-(N). The respective boot images 115(1)-(N) may include hypervisors, operating systems, services, etc. The respective configuration parameters 116(1)-(N) may include node-specific parameters, such as IP addresses, names, software keys, etc. Each of the boot/backup managers 112(1)-(N) may be configured to provide the respective boot images 115(1)-(N) and the respective configuration parameters 116(1)-(N) to the backup node 120. In some examples, part of the boot/backup managers 112(1)-(N) may execute in a pre-boot execution environment.

The backup node 120 may include a boot/backup manager 122 and local storage 124. The local storage 124 may be configured to store a boot image 125 and configuration parameters 126 associated with the computing nodes 110(1)-(N). The boot image 125 may include hypervisors, operating systems, services, etc. The configuration parameters 126 may include node-specific parameters, such as IP addresses, names, software keys, etc., for each of the computing nodes 110(1)-(N). The boot/backup manager 122 may be configured to provide the boot image 125 and the respective configuration parameters 126 to one or more of the computing nodes 110(1)-(N) in response to a request to initiate a remote boot operation. The boot/backup manager 122 may be further configured to update the boot image 125 and/or the configuration parameters 126 in response to a request from one or more of the computing nodes 110(1)-(N).

In operation, the system 100 may be configured to provide computing resources for a designated function, such as acting as a virtual file server for networked storage. While performing the designated function, processing tasks are allocated amongst the computing nodes 110(1)-(N) to leverage processing resources across many computing nodes, rather than overloading one of the computing nodes 110(1)-(N). The computing nodes 110(1)-(N) may communicate with each other via the network 150 to coordinate performance of tasks.

In response to a failure of one of the computing nodes 110(1)-(N), the other computing nodes may be assigned tasks that were previously assigned to the failed computing node. The failure may include a hardware failure (e.g., memory failure or hardware configuration failure) or a software failure (e.g., software configuration incompatibility), or a combination thereof. The increased workload to be performed by the remaining computing nodes 110(1)-(N) may reduce productivity of the system 100, in some examples. Thus, in some examples, in response to detection of a failure, the respective boot/backup manager 112(1)-(N) may automatically initiate a remote boot operation. In other examples, a user may be prompted to provide authorization to initiate the remote boot operation in response to detection of a failure. The remote boot operation may include providing a remote boot request to the boot/backup manager 122 via the network 150. In response to the request, the boot/backup manager 122 may provide the boot image 125 and the respective configuration parameters 126 associated with the failed computing node to the failed computing node via the network 150. The failed computing node may boot using the boot image 125 and the respective configuration parameters 126, and may resume normal operation if the remote boot operation is successful.

The failure of the computing node may be detected during a health check after a boot of the computing nodes 110(1)-(N), in some examples. In some examples, the failure of the computing node may be detected during a cluster check performed on the system 100, in some examples. In other examples, the failure may be detected based on a hardware or software exception thrown during normal operation that prevents access to a hardware device or loading of a software application, respectively, for example. In yet other examples, the failure may occur during a failed or interrupted software application upgrade such that one or more of the computing nodes 110(1)-(N) are unable to successfully boot up or starting/re-start. The respective boot/backup manager 112(1)-(N) for each of the computing nodes 110(1)-(N) may receive an indication of the detected failure and may initiate a reboot of the failed computing node directed to the backup node 120.

When the failure is addressed, the failed computing node may be configured to boot from the respective boot image 115(1)-(N) and the configuration parameters 116(1)-(N) retrieved from the local storage 114(1)-(N), and a reboot may be performed. In some examples, the reboot may be scheduled at a time that reduces operational impact, such as at a time when use of the system 100 is reduced. In some examples, repair of the failed computing node may include copying the boot image 125 and the configuration parameters 126 from the backup node 120 to the respective local storage 114(1)-(N), such as when a failure is associated with the local storage 114(1)-(N) or in response to an attempted software upgrade that resulted in the failure.

In addition to managing remote boot operations, the boot/backup managers 112(1)-(N) may be further configured to initiate backup operations associated with the respective computing nodes 110(1)-(N). For example, during a backup operation, the boot/backup managers 112(1)-(N) may provide updated boot images and/or configuration parameters from the boot images 115(1)-(N) and/or the configuration parameters 116(1)-(N), respectively, to the backup node 120. The backup node 120 may update the boot image 125 and the configuration parameters 126 based on the updated boot images and/or configuration parameters received from the computing nodes 110(1)-(N). In some examples, the boot/backup managers 112(1)-(N) and/or the backup node 120 may determine whether current boot images 115(1)-(N) differ from the boot image 125 by comparing checksum values derived from the boot images 115(1)-(N) and the boot image 125 using a hashing or checksum mechanism. The checksum values may be stored for easy comparison. When a different is detected based on different checksum values, a backup operation may be initiated. In some examples, the backups are coordinated through a single one of the boot/backup managers 112(1)-(N) to avoid duplication of backup operations or overwriting backup information. In some examples, the boot image 125 may include more than one boot image, such as when the computing nodes 110(1)-(N) have different hardware configurations that require different boot images. The backup operation may be initiated after a successful cluster check, which may be configured to detect hardware issues, software issues, configuration issues, network issues, etc. In some examples, the backup operation may be performed prior to a configuration update to the computing nodes 110(1)-(N) of the system 100, such as upgrading installed software or changing a hardware configuration. In some examples, the backup operation may be again performed after a successful configuration update to the computing nodes 110(1)-(N) of the system 100. The update may include providing a request to the backup node 120 from the computing nodes 110(1)-(N) to initiate an update to the boot image 125 and/or the configuration parameters 126. The backup node 120 may update the boot image 125 and the configuration parameters 126 in response to receipt of the updated boot image and/or configuration parameters.

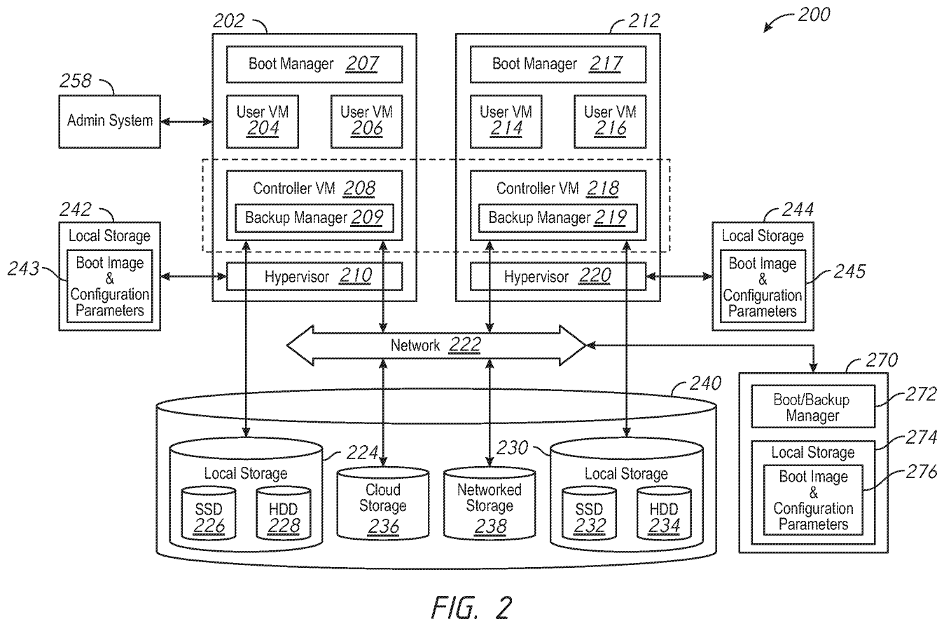

FIG. 2 is a block diagram of a distributed computing system 200, in accordance with an embodiment of the present disclosure. The distributed computing system 200 generally includes a computing node 202 and a computing node 212 and storage 240 connected to a network 222. The distributed computing system 200 may further include a backup node 270 connected to the network 222. The network 222 may be any type of network capable of routing data transmissions from one network device (e.g., the computing node 202, the computing node 212, the storage 240, and the backup node 270) to another. For example, the network 222 may be a local area network (LAN), wide area network (WAN), intranet, Internet, or a combination thereof. The network 222 may be a wired network, a wireless network, or a combination thereof.

The storage 240 may include local storage 224, local storage 230, cloud storage 236, and networked storage 238. The local storage 224 may include, for example, one or more solid state drives (SSD 226) and one or more hard disk drives (HDD 228). Similarly, the local storage 230 may include SSD 232 and HDD 234. In yet other examples, the local storage 240 may include persistent memory. The local storage 224 and the local storage 230 may be directly coupled to, included in, and/or accessible by a respective the computing node 202 and/or the computing node 212 without communicating via the network 222. Other nodes, however, may access the local storage 224 and/or the local storage 230 using the network 222. Cloud storage 236 may include one or more storage servers that may be stored remotely to the computing node 202 and/or the computing node 212 and accessed via the network 222. The cloud storage 236 may generally include any suitable type of storage device, such as HDDs SSDs, or optical drives. Networked storage 238 may include one or more storage devices coupled to and accessed via the network 222. The networked storage 238 may generally include any suitable type of storage device, such as HDDs SSDs, and/or NVM Express (NVMe). In various embodiments, the networked storage 238 may be a storage area network (SAN). The computing node 202 is a computing device for hosting virtual machines (VMs) in the distributed computing system 200.

The computing node 202 may be configured to execute a hypervisor 210, a controller VM 208 and one or more user VMs, such as user VMs 204, 206. The user VMs including the user VM 204 and the user VM 206 are virtual machine instances executing on the computing node 202. The user VMs including the user VM 204 and the user VM 206 may share a virtualized pool of physical computing resources such as physical processors and storage (e.g., the storage 240). The user VMs including the user VM 204 and the user VM 206 may each have their own operating system, such as Windows or Linux. While a certain number of user VMs are shown, generally any suitable number may be implemented. User VMs may generally be provided to execute any number of applications which may be desired by a user.

The hypervisor 210 may be any type of hypervisor. For example, the hypervisor 210 may be ESX, ESX(i), Hyper-V, KVM, or any other type of hypervisor. The hypervisor 210 manages the allocation of physical resources (such as the storage 240 and physical processors) to VMs (e.g., user VM 204, user VM 206, and controller VM 208) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 208 and/or the controller VM 218, may provide services for the user VMs in the computing node. As an example of functionality that a controller VM may provide, the controller VM 208 may provide virtualization of the storage 240. Accordingly, the storage 240 may be referred to as a storage pool. Controller VMs may provide management of the distributed computing system 200. Examples of controller VMs may execute a variety of software and/or may serve the I/O operations for the hypervisor and VMs running on that node. In some examples, a SCSI controller, which may manage SSD and/or HDD devices described herein, may be directly passed to the CVM, e.g., leveraging PCI Pass-through in some examples. In this manner, controller VMs described herein may manage input/output (I/O) requests between VMs on a computing node and available storage, such as the storage 240.

The computing node 212 may include user VM 214, user VM 216, a controller VM 218, and a hypervisor 220. The user VM 214, the user VM 216, the controller VM 218, and the hypervisor 220 may be implemented similarly to analogous components described above with respect to the computing node 202. For example, the user VM 214 and the user VM 216 may be implemented as described above with respect to the user VM 204 and the user VM 206. The controller VM 218 may be implemented as described above with respect to the controller VM 208. The hypervisor 220 may be implemented as described above with respect to the hypervisor 210. In some examples, the hypervisor 220 may be a different type of hypervisor than the hypervisor 210. For example, the hypervisor 220 may be Hyper-V, while the hypervisor 210 may be ESX(i). In some examples, the hypervisor 210 may be of a same type as the hypervisor 220.

The controller VM 208 and the controller VM 218 may communicate with one another via the network 222. By linking the controller VM 208 and the controller VM 218 together via the network 222, a distributed network of computing nodes including the computing node 202 and the computing node 212, can be created.

Controller VMs, such as the controller VM 208 and the controller VM 218, may each execute a variety of services and may coordinate, for example, through communication over network 222. Services running on controller VMs may utilize an amount of local memory to support their operations. For example, services running on the controller VM 208 may utilize memory in local memory 242. Services running on the controller VM 218 may utilize memory in local memory 244. The local memory 242 and the local memory 244 may be shared by VMs on the computing node 202 and the computing node 212, respectively, and the use of the local memory 242 and/or the local memory 244 may be controlled by the hypervisor 210 and the hypervisor 220, respectively. The local memory 242 and 244 may include memory installed on the computing node 202 and 212, respectively. The local memory 242 may store a boot image and configuration parameters 243 and the local memory 244 may store a boot image and configuration parameters 245. The boot images and configuration parameters 243, 245 may each include hypervisors, operating systems, services, IP addresses, names, software keys, etc. The computing node 202 may use the boot image and configuration parameters 243 to boot and load one or more of the hypervisor 210, the controller VM 208, the user VMs 204 and 206, etc. The computing node 212 may use the boot image and configuration parameters 245 to boot and load one or more of the hypervisor 220, the controller VM 218, the user VMs 214 and 216, etc. In some examples, the boot image and configuration parameters 243 and the boot image and configuration parameters 245 may be stored in the local storage 224 and the local storage 230, respectively. Moreover, multiple instances of the same service may be running throughout the distributed system—e.g. a same services stack may be operating on each controller VM. For example, an instance of a service may be running on the controller VM 208 and a second instance of the service may be running on the controller VM 218.

Generally, controller VMs described herein, such as the controller VM 208 and the controller VM 218 may be employed to control and manage any type of storage device, including all those shown in the storage 240, including the local storage 224 (e.g., SSD 226 and HDD 228), the cloud storage 236, and the networked storage 238. Controller VMs described herein may implement storage controller logic and may virtualize all storage hardware as one global resource pool (e.g., the storage 240) that may provide reliability, availability, and performance. IP-based requests are generally used (e.g., by user VMs described herein) to send I/O requests to the controller VMs. For example, user VM 204 and user VM 206 may send storage requests to the controller VM 208 using over a virtual bus. Controller VMs described herein, such as the controller VM 208, may directly implement storage and I/O optimizations within the direct data access path. Communication between hypervisors and controller VMs described herein may occur using IP requests.

Note that controller VMs are provided as virtual machines utilizing hypervisors described herein—for example, the controller VM 208 is provided behind hypervisor 210. Since the controller VMs run “above” the hypervisors examples described herein may be implemented within any virtual machine architecture, since the controller VMs may be used in conjunction with generally any hypervisor from any virtualization vendor.

Virtual disks (vDisks) may be structured from the storage devices in the storage 240, as described herein. A vDisk generally refers to the storage abstraction that may be exposed by a controller VM to be used by a user VM. In some examples, the vDisk may be exposed via iSCSI (“internet small computer system interface”) or NFS (“network file system”) and may be mounted as a virtual disk on the user VM. For example, the controller VM 208 may expose one or more vDisks of the storage 240 and the hypervisor may attach the vDisks to one or more VMs, and the virtualized operating system may mount a vDisk on one or more user VMs, such as the user VM 204 and/or the user VM 206.

During operation, the user VMs (e.g., the user VM 204 and/or the user VM 206) may provide storage input/output (I/O) requests to controller VMs (e.g., the controller VM 208 and/or the hypervisor 210). Accordingly, a user VM may provide an I/O request over a virtual bus to a hypervisor as an iSCSI and/or NFS request. Internet Small Computer system Interface (iSCSI) generally refers to an IP-based storage networking standard for linking data storage facilities together. By carrying SCSI commands over IP networks, iSCSI can be used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. Network File system (NFS) refers to an IP-based file access standard in which NFS clients send file-based requests to NFS servers via a proxy folder (directory) called “mount point”. Generally, then, examples of systems described herein may utilize an IP-based protocol (e.g., iSCSI and/or NFS) to communicate between hypervisors and controller VMs. Other protocols, such as server message block (SMB) or common internet file system (CIFS) protocols, may be used without departing from the scope of the disclosure

During operation, examples of user VMs described herein may provide storage requests using an IP based protocol, such as SMB. The storage requests may designate the IP address for a controller VM from which the user VM desires I/O services. The storage request may be provided from the user VM to a virtual switch within a hypervisor to be routed to the correct destination. For examples, the user VM 204 may provide a storage request to hypervisor 210. The storage request may request 1/O services from controller VM 208 and/or the controller VM 218. If the request is to be intended to be handled by a controller VM in a same service node as the user VM (e.g., the controller VM 208 in the same computing node as the user VM 204) then the storage request may be internally routed within the computing node 202 to the controller VM 208. In some examples, the storage request may be directed to a controller VM on another computing node. Accordingly, the hypervisor (e.g., the hypervisor 210) may provide the storage request to a physical switch to be sent over a network (e.g., the network 222) to another computing node running the requested controller VM (e.g., the computing node 212 running the controller VM 218).

Accordingly, hypervisors described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software), since each computing node may include its own controller VM. Each new computing node in the system may include a controller VM to share in the overall workload of the system to handle storage tasks. Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

In some examples, the distributed computing system 200 may support remote boot operations in response to failure of one of the computing nodes 202, 212. As previously described, the computing node 202 may boot from the boot image and configuration parameters 243 and the computing node 212 may boot from the 212. In response to a failure of one of the computing nodes 202, 212 (e.g., a hardware failure, a software failure, or a combination thereof), a respective boot manager 207, 217 running on the computing nodes 202, 212 may automatically initiate a remote boot operation. In other examples, a user may be prompted to provide authorization to initiate the remote boot operation in response to detection of a failure. The remote boot operation may include rebooting the failed computing node 202 or 212 using remote boot image resources of the backup node 270 (e.g., the boot/backup manager 272 and the boot image and configuration parameters 276). The boot image and configuration parameters 276 may include hypervisors, operating systems, services, IP addresses, names, software keys, etc., associated with the computing nodes 202, 212. The remote boot operation may include the respective boot manager 207, 217 configured to provide a remote boot request to the boot/backup manager 272 of the backup node 270 via the network 222. The backup node 270 may store a boot image and configuration parameters 276 at local storage 274. In response to the request, the 222 may provide the stored boot image and configuration parameters 276 associated with the failed computing node 202 or 212 to the failed computing node 202 or 212 via the network 222. The failed computing node 202 or 212 may boot using the received boot image and configuration parameters 276, and may resume normal operation if the remote boot operation is successful.

The failure of the computing node may be detected during a health check after a boot of the computing nodes 202, 212, in some examples. In some examples, the failure of the computing node may be detected during a cluster check performed on the system 200, in some examples. In other examples, the failure may be detected based on a hardware or software exception thrown during normal operation that prevents access to a hardware device or loading of a software application, respectively, for example. The respective boot manager 207, 217 for each of the computing nodes 202, 212 may receive an indication of the detected failure and may initiate a reboot of the computing node 202, 212 directed to the backup node 270. In some examples, the boot managers 207, 217 may execute in a pre-boot execution environment.

When the failure is addressed, the boot manager 207, 217 of the failed computing node 202 or 212 may be configured to boot from the respective boot image and configuration parameters 243 or boot image and configuration parameters 245, and a reboot may be performed. In some examples, the reboot may be scheduled at a time that reduces operational impact, such as at a time when use of the system 200 is reduced. In some examples, repair of the failed computing node 202 or 212 may include copying the boot image and configuration parameters 276 from the backup node 270 to the respective local memory 242, boot image and configuration parameters 245, such as when a failure is associated with the local memory 242 or 244 or in response to an attempted software upgrade that resulted in the failure.

In addition, each of the computing nodes 202, 212 may include a respective backup manager service 209, 219 running on the respective controller VM 208, 218. The backup manager services 209, 219 may be configured to initiate backup operations for the respective computing nodes 202, 212. For example, during a backup operation, the backup manager services 209, 219 may communicate with the boot/backup manager 272 provide updated boot images and/or configuration parameters from the boot image and configuration parameters 243 and the boot image and configuration parameters 245, respectively, to the backup node 270. The backup node 270 may update the boot image and configuration parameters 276 based on the updated boot images and/or configuration parameters received from the backup manager services 209, 219. In some examples, the backups may be coordinated through a single one of the backup manager services 209, 219 to avoid duplication of backup operations or overwriting backup information. In some examples, the boot image and configuration parameters 276 may include more than one boot image, such as when the computing nodes 202, 212 have different hardware configurations that require different boot images. The backup operation may be initiated after a successful cluster check, which may be configured to detect hardware issues, software issues, configuration issues, network issues, etc. In some examples, the backup operation may be performed prior to a configuration update to the computing nodes 202, 212 of the system 200, such as upgrading installed software or changing a hardware configuration. In some examples, the backup operation may be again performed after a successful configuration update to the computing nodes 202, 212 of the system 200. The update may include providing a request to the backup node 270 from the backup manager services 209, 219 to initiate an update to the boot image and configuration parameters 276. The backup node backup node 270 may update the boot image and configuration parameters 276 in response to receipt of the updated boot image and/or configuration parameters.

In some examples, remote boot of the computing nodes 202, 212 may be controlled by an administration system. For example, as shown in FIG. 2, the distributed computing system 200 may include or be connected to an administrator system 258 that is configured to control remote boot of the computing nodes 202, 212 of the distributed computing system 200. The administrator system 258 may be implemented using, for example, one or more computers, servers, laptops, desktops, tablets, mobile phones, or other computing systems. In other examples, the administrator system 258 may be wholly and/or partially implemented using one of the computing nodes 202, 212 of the distributed computing system 200. However, in some examples, the administrator system 258 may be a different computing system from the distributed computing system 200 and may be in communication with one or more controller VMs 208, 218 of the distributed computing system 200 using a wired or wireless connection (e.g., over a network). The administrator system 258 may provide a request to the respective boot manager 207, 217 via the respective controller VM 208, 218 to initiate a remote boot operation in some examples. In other examples, the administrator system 258 may provide a request to the respective boot manager 207, 217 via the respective controller VM 208, 218 to revert to local boot operations from a remote boot configuration, such as after an issue causing a failure of one of the computing nodes 202, 212 has been corrected.

The administrator system 258 may host one or more user interfaces. The user interfaces may receive input from one or more users (e.g., administrators) using one or more input device(s) of the administrator system, such as, but not limited to, a keyboard, mouse, touchscreen, and/or voice input. The user interface may provide input to the controller VM(s) 208, 218 and/or may receive data from the controller VM(s) 208, 218. In some examples, a user may interact with the user interface of the administrator system 258 to set up particular remote boot operations on the distributed computing system 200.

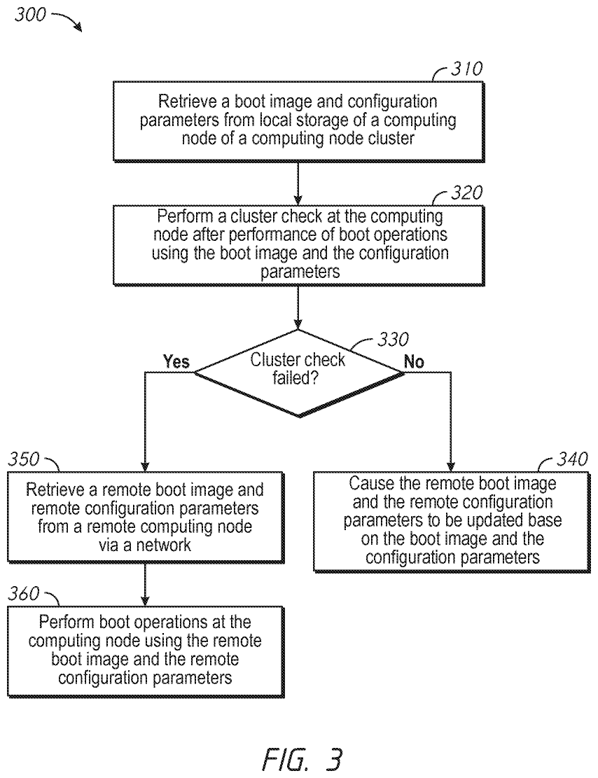

FIG. 3 is a flowchart of a method 300 remote boot support in a distributed computing system in accordance with some embodiments of the disclosure. The method 300 may be performed by the distributed computing system 100 of FIG. 1, the distributed computing system 200 of FIG. 2, or combinations thereof. In a specific example, one or more boot managers, such as the boot/backup managers 112(1)-(N) of FIG. 1, the boot managers 207, 217 of FIG. 2, or combinations thereof may implement the method 300.

The method 300 may include retrieving a boot image and configuration parameters from local storage of a computing node of a computing node cluster, at 310. The computing node may include any of the computing nodes 110(1)-(N) of FIG. 1 and/or the computing nodes 202, 212 of FIG. 2. The local storage may include any of the local storages 114(1)-(N) of FIG. 1 and/or any of the local memories 242, 244 of FIG. 2. The boot image and the configuration parameters may include any of the boot images 115(1)-(N) and the configuration parameters 116(1)-(N), respectively, of FIG. 1 and/or either of the boot images and configuration parameters 243, 245 of FIG. 2.

The method 300 may further include performing a cluster check at the computing node after performance of boot operations using the boot image and the configuration parameters, at 320. The cluster check may verify whether a configuration of the computing node is valid. In some examples, the method 300 may further include initiating performance of the cluster check at the computing node before updating the boot image and the configuration parameters retrieved from the local storage. In some examples, the method 300 may further include initiating performance of the cluster check at the computing node in response to completion of the update of the boot image and the configuration parameters retrieved from the local storage. In some examples, performing the cluster check comprises checking installed services, hardware and software version compatibility, hardware health, network connectivity, or combinations thereof. In some examples, the cluster check fails if retrieval of the boot image and the configuration parameters from the local storage fails.

The method 300 may further include determining whether the cluster check fails, at 330. In response to failing the cluster check, the method 300 may further include retrieving a remote boot image and remote configuration parameters from a remote computing node via a network, at 350, and performing boot operations at the computing node using the remote boot image and the remote configuration parameters, at 360. In some examples, retrieval of the remote boot image and the remote configuration parameters, and performance of the boot operations using the remote boot image and the remote configuration parameters may be via a boot manager, such as any of the boot/backup managers 112(1)-(N) of FIG. 1 and/or the boot managers 207, 217 of FIG. 2. In some examples, in response to failing the cluster check, the method 300 may further include providing an alert (e.g., to notify an administrator) that a cluster check has failed. The alert may include identification of the computing node that failed and the cluster check that detected the failure. In some examples, the boot manager may execute in a pre-boot execution environment. The remote computing node may include the backup node 120 of FIG. 1 and/or the backup node 270 of FIG. 2. The remote boot image and the remote configuration parameters may include the boot image 125 and the configuration parameters 126, respectively, of FIG. 1 and/or the boot image and configuration parameters boot image and configuration parameters 276 of FIG. 2. In some examples, in response failing the cluster check, the method 300 may further include setting an indicator to default to performance of boot operations using the remote boot image and the remote configuration parameters. In some examples, the method may further include resetting the indicator to default to performance of boot operations using the boot image and the configuration parameters retrieved from the local storage in response to a received request.

In response to passing the cluster check, the method 300 may further include causing the remote boot image and remote configuration parameters to be updated based on a local boot image and local configuration parameters, at 340. Either of the backup manager services 209, 219 of FIG. 2 may cause the remote boot image and remote configuration parameters to be updated.

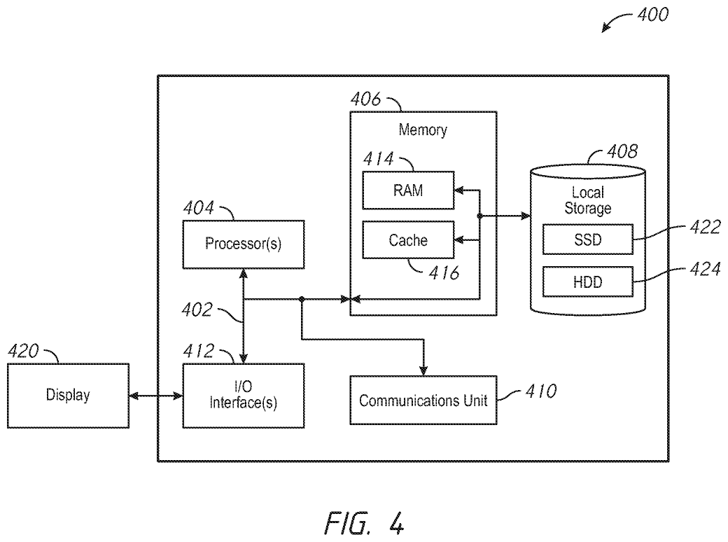

FIG. 4 depicts a block diagram of components of a computing node 400 in accordance with an embodiment of the present disclosure. It should be appreciated that FIG. 4 provides only an illustration of one implementation and does not imply any limitations with regard to the environments in which different embodiments may be implemented. Many modifications to the depicted environment may be made. The computing node 400 may implemented as any of the computing nodes 110(1)-(N) or the backup node 120 of FIG. 1, the computing node 202 and/or the computing node 212 of FIG. 2, or any combinations thereof. The computing node 400 may be configured to implement the method 300 described with reference to FIG. 3, in some examples, to perform remote boot operations.

The computing node 400 includes a communications fabric 402, which provides communications between one or more processor(s) 404, memory 406, local storage 408, communications unit 410, I/O interface(s) 412. The communications fabric 402 can be implemented with any architecture designed for passing data and/or control information between processors (such as microprocessors, communications and network processors, etc.), system memory, peripheral devices, and any other hardware components within a system. For example, the communications fabric 402 can be implemented with one or more buses.

The memory 406 and the local storage 408 are computer-readable storage media. In this embodiment, the memory 406 includes random access memory RAM 414 and cache 416. In general, the memory 406 can include any suitable volatile or non-volatile computer-readable storage media. IN some examples, the local storage 408 may include persistent memory and/or non-volatile memory express (NVMe). The local storage 408 may be implemented as described above with respect to the local storage 224 and/or local storage 230 of FIG. 2. In this embodiment, the local storage 408 includes an SSD 422 and an HDD 424, which may be implemented as described above with respect to SSD 226, SSD 232 and HDD 228, HDD 234, respectively, of FIG. 2.

Various computer instructions, programs, files, images, etc. may be stored in local storage 408 for execution by one or more of the respective processor(s) 404 via one or more memories of memory 406. In some examples, local storage 408 includes a magnetic HDD 424. Alternatively, or in addition to a magnetic hard disk drive, local storage 408 can include the SSD 422, a semiconductor storage device, a read-only memory (ROM), an erasable programmable read-only memory (EPROM), a flash memory, or any other computer-readable storage media that is capable of storing program instructions or digital information.

The media used by local storage 408 may also be removable. For example, a removable hard drive may be used for local storage 408. Other examples include optical and magnetic disks, thumb drives, and smart cards that are inserted into a drive for transfer onto another computer-readable storage medium that is also part of local storage 408.

Communications unit 410, in these examples, provides for communications with other data processing systems or devices. In these examples, communications unit 410 includes one or more network interface cards. Communications unit 410 may provide communications through the use of either or both physical and wireless communications links.

I/O interface(s) 412 allows for input and output of data with other devices that may be connected to computing node 400. For example, I/O interface(s) 412 may provide a connection to external device(s) 418 such as a keyboard, a keypad, a touch screen, and/or some other suitable input device. External device(s) 418 can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 408 via I/O interface(s) 412. I/O interface(s) 412 also connect to a display 420.

Display 420 provides a mechanism to display data to a user and may be, for example, a computer monitor.

What is claimed is:

1. A method comprising:
retrieving a boot image and configuration parameters from local storage of a computing node of a computing node cluster;
performing a cluster check at the computing node after performance of boot operations using the boot image and the configuration parameters; and
in response to failing the cluster check:
retrieving a remote boot image and remote configuration parameters from a remote computing node via a network; and
performing boot operations at the computing node using the remote boot image and the remote configuration parameters.

2. The method of claim 1, wherein the cluster check fails if retrieval of the boot image and the configuration parameters from the local storage fails.

3. The method of claim 1, further comprising, in response to failing the cluster check, setting an indicator to default to performance of boot operations using the remote boot image and the remote configuration parameters.

4. The method of claim 3, further comprising resetting the indicator to default to performance of boot operations using the boot image and the configuration parameters retrieved from the local storage in response to a received request.

5. The method of claim 1, further comprising, in response to passing the cluster check, causing the remote boot image and the remote configuration parameters to be updated based on the boot image and the configuration parameters retrieved from the local storage.

6. The method of claim 1, further comprising initiating performance of the cluster check at the computing node before updating the boot image and the configuration parameters retrieved from the local storage.

7. The method of claim 6, further comprising initiating performance of the cluster check at the computing node in response to completion of the update of the boot image and the configuration parameters retrieved from the local storage.

8. The method of claim 1, wherein performing the cluster check comprises checking installed services, hardware and software version compatibility, hardware health, network connectivity, or combinations thereof.

9. The method of claim 1, wherein the boot image includes an operating system and system services.

10. A computing node comprising:
at least one processor; and
memory storing instructions that, when executed by the at least one processor, cause the computing node to:
perform a cluster check to verify a valid configuration;
in response to failing the cluster check:
initiate a reboot of the computing node;
during the reboot of the computing node, retrieve a remote boot image and remote configuration parameters from a remote computing node via a network to perform the reboot.

11. The computing node of claim 10, wherein the instructions further cause the computing node to, in response to passing the cluster check, causing the remote boot image and the remote configuration parameters to be updated based on a local boot image and local configuration parameters.

12. The computing node of claim 10, wherein the instructions further cause the computing node to, in response to failing the cluster check, set an indicator to default to performance of boot operations using the remote boot image and the remote configuration parameters.

13. The computing node of claim 10, wherein the instructions further cause the computing node to after completion of the reboot of the computing node:
perform a second cluster check to verify a valid configuration;
in response to passing the cluster check, storing the remote boot image and the remote configuration parameters at the memory.

14. The computing node of claim 10, wherein the remote boot image includes an operating system.

15. The computing node of claim 14, wherein the operating system includes a hypervisor.

16. The computing node of claim 10, wherein the instructions that cause the computing node to retrieve the remote boot image and the remote configuration parameters from the remote computing node via the network are part of a pre-boot execution environment.

17. A computing node comprising:
a memory configured to store a boot image; and
a boot/backup manager configured to perform a cluster check to determine a valid configuration, wherein, in response to failing the cluster check, the boot/backup manager is configured to retrieve a remote boot image and remote configuration parameters from a remote computing node via a network and perform boot operations using the remote boot image and the remote configuration parameters.

18. The computing node of claim 17, wherein the boot/backup manager is configured to retrieve the remote boot image and the remote configuration parameters from the remote computing node via the network while operating in a pre-boot execution environment.

19. The computing node of claim 18, wherein the boot/backup manager is further configured to, in response to passing the cluster check, cause the remote boot image and the remote configuration parameters to be updated based on a local boot image and local configuration parameters.

20. The computing node of claim 19, wherein, while using the remote boot image and the remote configuration, the boot/backup manager is configured to initiate a replacement of the local boot image and the local configuration parameters with the remote boot image and the remote configuration parameters in response to receipt of indication of a repair associated with the failed cluster check.
